(19) United States
(12) Patent Application Publication
(10) Pub. No.: US 2005/0066245 A1
(43) Pub. Date: Mar. 24, 2005

(54) Arrangement having a data processing device and a memory

(75) Inventor: Wilhard Christophorus Von Wendorff, Munchen (DE)

Correspondence Address: Andreas Grubert;Baker Botts L.L.P., 910 Louisiana, One Shell Plaza, Houson, TX, 77002-4995, US

(73) Assignee: Infineon Technologies AG

(21) Appl. No.: 10/926,713

(22) Filed: Aug. 26, 2004

(30) Foreign Application Priority Data
Aug. 29, 2003 (DE) 103 40 236.5

(51) Int. Cl. H04L 9/00; G01R 31/28

(52) U.S. Cl. 714/732

(57) ABSTRACT

An arrangement having a data processing device and a memory for storing data which is required by the data processing device is described. The described arrangement is defined by the fact that it contains a checking device which generates signature data when data is read out of the memory, compares the generated signature data with signature data which is fed to the checking device and is assigned to the data which is output from the memory, and determines, as a function of the result of this comparison, whether the data which is output from the memory can be released for use by the data processing device.

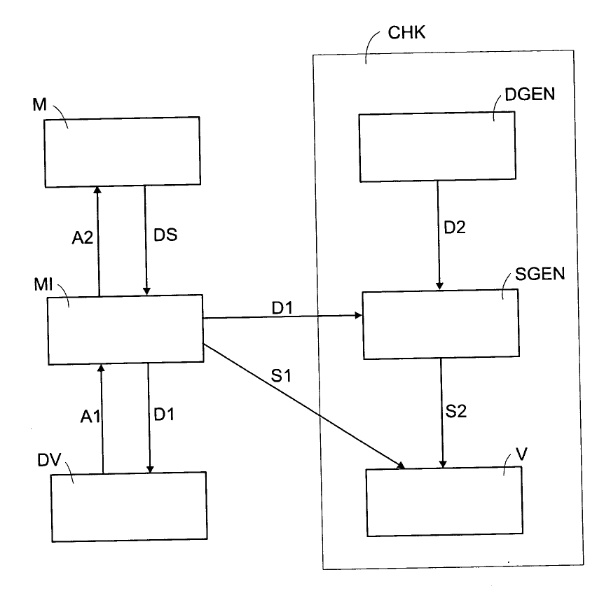

### PRIORITY

This application claims priority to German application no. 103 40 236.5 filed Aug. 29, 2003.

### TECHNICAL FIELD OF THE INVENTION

The present invention relates to an arrangement having a data processing device and a memory for storing data which is required by the data processing device.

### BACKGROUND OF THE INVENTION

Such arrangements have been known for many years in innumerable embodiments and therefore do not require any more detailed explanation.

If such an arrangement or a system which contains such an arrangement is used for applications which are critical for safety, for example for controlling the antilock brake system or the airbag of a motor vehicle, precautions must be taken which ensure that the arrangement, or the system containing it, operates without faults under all circumstances; if the arrangement or the system containing it were not to operate without faults this could have life-threatening consequences.

The requirements which have to be fulfilled in systems which are critical for safety include, inter alia, the fact that the data which is read out from the memory by the data processing device is free of errors. This may be brought about, for example, by using error correction data (ECC) which is stored in a second memory. In this case, when data which is stored in the first memory and is referred to below as useful data is read out, the error correction data which is stored in the second memory is also read out, and it is determined whether the useful data is free of errors by comparing the useful data and the error correction data; errors contained in this data can be detected using the error correction data, and even partially corrected.

However, it is not possible to detect all errors by the aforesaid method. For example, errors which result from the fact that the data processing device outputs the incorrect address, or that an address decoder which is provided between the data processing device and the memory decodes the address incorrectly, are not detected.

A further possible way of detecting errors is that the system is of redundant design and contains a plurality of components which carry out the same operation simultaneously, or with a small time offset, or monitor one another mutually. Such systems are very large, require a high degree of expenditure on development and manufacture, and are correspondingly expensive.

### SUMMARY OF THE INVENTION

The present invention is therefore based on the object of developing such an arrangement in such a way that errors which occur can be detected more reliably than was previously the case, with little outlay.

This object can be achieved according to the invention by an arrangement comprising a data processing device and a memory for storing data which is required by the data processing device, wherein the arrangement comprises a checking device operable to generate signature data when data is read out of the memory, to compare the generated signature data with signature data which is fed to the checking device and is assigned to the data which is output from the memory, and operable to determine, as a function of the result of this comparison, whether the data which is output from the memory can be released for use by the data processing device.

The signature data which is fed to the checking device can be stored in the arrangement. The signature data which is fed to the checking device can also be stored in the memory. The signature data which is fed to the checking device can be stored at the same address as the data to which said signature data is assigned, with the result that, when data is read out of the memory, both the data which is to be read out and the signature data which is assigned thereto is output from the memory. The checking device may generate the signature data to be generated by it, in such a way that the signature data which is generated by the checking device corresponds to the signature data which is fed to the checking device if the data which is output from the memory can be released for use by the data processing device, and that the signature data which is generated by the checking device does not correspond to the signature data which is fed to the checking device if the data which is output from the memory cannot be released for use by the data processing device. Both the signature data which is generated by the checking device and the signature data which is fed to the checking device may contain information which represents specific properties of the data on which the generation of the signature data is based, and the information which is contained in signature data which is generated by the checking device, and the information which is contained in the signature data which is fed to the checking device, may represent the same properties. The information which is contained in signature data which can be generated by the checking device, and the information which is contained in the signature data which is fed to the checking device, can be coded in the same way. The signature data which is fed to the checking device may contain information about the data to which it is assigned. The signature data which is fed to the checking device may also contain an error correction code, which is used to detect errors which are present in the data which is assigned to the signature data. The signature data which is fed to the checking device may also contain a single error correction double error detection code. The data which is output from the memory can be fed to the checking device, and the data which is output from the memory can be used as the basis for the generation of signature data which is performed by the checking device. The signature data which is fed to the checking device may contain information about the address at which the data to which the signature data is assigned is stored in the memory. The checking device may contain a data generating device which outputs the address from which the data processing device would have to read data out of the memory, and the address which is output by the data generating device is used as the basis for the generation of signature data which is to be performed by the checking device. The signature data which is fed to the checking device may contain the signature of an access control code, the access control code representing conditions under which the data to which the signature data is assigned can be accessed or cannot be accessed. The checking device may contain a data generating device which outputs data which represents the instantaneous status of the arrangement, or the instantaneous status of the system containing the arrangement, or the instantaneous status of a specific component of the system containing the arrangement, and wherein the data which is output from the data generating device is used as the basis for the generation of signature data which is to be performed by the checking device. The checking device may contain a data generating device which outputs data which contains information about the device which accesses the memory at a particular time, and wherein the data which is output from the data generating device is used as the basis for the generation of signature data which is to performed by the checking device. The checking device may contain a data generating device which outputs a code word which is fed to the arrangement by the user of the arrangement, and wherein the code word which is output from the data generating device is used as the basis for the generation of signature data which is to be performed by the checking device. The checking device and the remaining components of the arrangement can be components of various local domains of the circuit forming the arrangement. The checking device may contain a data generating device, a signature generating device and a signature comparing device. The signature generating device which generates the signature data which is to be generated by the checking device, data which is fed to the signature generating device by the data generating device and/or by a component of the arrangement which is not associated with the checking device can be used as the basis for the generation of signature data. The signature comparing device may carry out the comparison which is to be carried out by the checking device, the signature data which is generated by the signature generating device and the signature data which is fed to the signature comparing device from outside the checking device may be compared by the comparison. The data generating device and the signature generating device on the one hand, and the signature comparing device on the other, can be components of different local domains of the circuit forming the arrangement.

The arrangement according to the invention is defined by the fact that it contains a checking device which
generates signature data when data is read out of the memory,
compares the generated signature data with signature data which is fed to the checking device and is assigned to the data which is output from the memory, and
determines, as a function of the result of this comparison, whether the data which is output from the memory can be released for use by the data processing device.

The signature data items which are compared with one another can contain any desired information, for example an error correction code (ECC), information about the address at which the data which is to be read out of the memory is stored in said memory, an access control code which can be used to implement access restrictions to the memory, and a large amount of other information in addition. The claimed arrangement thus makes it possible for a wide variety of errors to be detected in a uniform and at the same time very simple fashion, even errors which it was previously impossible to detect at all, or could only be detected with a large amount of outlay.

Advantageous developments of the invention can be found in the following description and the figures.

### BRIEF DESCRIPTION OF THE DRAWINGS

The invention is described in more detail below by means of an exemplary embodiment and with reference to the figure.

The figure shows the design of the arrangement which is described in more detail below.

### DETAILED DESCRIPTION OF THE PREFERRED EMBODIMENTS

As is apparent from the figure, the arrangement which is presented here contains a memory M, a memory interface MI, a data processing device DV and a checking device CHK, the checking device CHK containing a data generating device DGEN, a signature generating device SGEN and a signature comparing device V.

In the example under consideration, the arrangement described is a component of a microcontroller. However, it could also be a component of a different program-controlled unit such as, for example, a microprocessor or a signal processor, or be a component of any desired other device. The arrangement could also be distributed among a plurality of semiconductor chips.

Of the aforesaid components of the arrangement illustrated here, in the example under consideration,
the memory M is formed by an internal flash memory of the microcontroller,
the data processing device DV is formed by a first core of the microcontroller,
the data generating device DGEN is formed by a second core of the microcontroller, and
the remaining components of the arrangement are formed by corresponding logic circuits of the microcontroller.

However there is no restriction on this. For example
the data processing device DV could also be a DMA controller or some other microcontroller component which accesses the memory M,
the data generating device DGEN could also be a component of the first core of the microcontroller, or a DMA controller, or a memory device such as, for example, a register.

There is also no restriction on the data processing device DV reading out itself the data which is stored in the memory M. The reading out of the data which is to be processed by the data processing device from the memory M could also be carried out or brought about by some other device.

However, as will be understood even better below, it is preferably the case that the checking device CHK or its components DGEN, SGEN and V, are formed by different microcontroller components than the remaining components of the arrangement which is presented here. However, it should at least be the case that the checking device CHK and the rest of the arrangement described here have the smallest possible number of commonly used circuit parts. That is to say if, for example, the data processing device DV and the data generating device DGEN are formed by the same core of the microcontroller, it should at least be the case that the address which is output by the data processing device DV, on the one hand, and the data which is output by the data generating device, on the other, are generated by different components of the core which are independent of one another, or are output at least via different terminals of the core and are passed on via different lines.

The data generating device DGEN and the signature generating device SGEN, on the one hand, and the signature comparing device, V on the other, are also preferably implemented by different parts of the circuit forming the arrangement.

The arrangement which is presented here is therefore preferably distributed among three local domains, the first local domain containing the data processing device DV, the memory interface MI and the memory M, the second local domain containing the data generating device DGEN and the signature generating device SGEN, and the third local domain containing the signal comparing device V.

This makes it possible to ensure that the checking device CHK operates particularly reliably; in particular there is thus only a very small probability that the checking device is operating incorrectly owing to errors occurring in other parts of the arrangement.

A plurality of data words are stored in the memory M, each data word containing useful data and signature data which is assigned to the useful data. In the example under consideration, each data word comprises 72 bits, of which 64 bits (for example the bits 0 to 63 of each data word) are reserved for the useful data, and 8 bits (for example the bits 64 to 71 of each data word) are reserved for the signature data. However, it is already to be noted at this point that there is no restriction on this. The data words can also be longer or shorter, and any desired different length of the useful data and of the signature data than in the example under consideration can be selected.

Addresses which are fed via the memory M can be accessed via the individual data words. The addresses comprise 8 bits in the example under consideration. However, they may also comprise more or fewer bits.

The writing to and the reading of the memory M are carried out on a data word basis. That is to say when access operations to the memory M are carried out, the useful data and the assigned signature data (which is to be stored, or is stored, at the same address) is transmitted to the memory or output from the memory respectively.

The aforesaid useful data is that data which a device accessing the memory M would like to read out of the memory M when there is a reading access operation to it. The signature data is data which the checking device CHK uses to check whether the useful data which is stored together with the signature data in a memory word can be released for use by the device which reads out said data from the memory.

The signature data which is stored in the memory M can be generated inside or outside the device containing the arrangement.

The information contained in the signature data depends on the purpose of use of the checking device CHK. In the example under consideration, the signature data can be used to detect, and if appropriate, to correct errors which are contained in the useful data, and/or to detect the fact that the memory M has been incorrectly addressed, and/or to detect inadmissible access operations to the memory M. More details on this will be given later.

The device which accesses the memory M is the data processing device DV in the example under consideration. Here, in particular the reading out of data stored in memory M by the data processing device DV is of interest.

If the data processing device DV would like to read out data, to be more precise useful data, from the memory M, it outputs the address at which this data is stored in the memory M. This address is designated by the reference symbol A1 in the figure.

The address A1 is converted by an addressing logic contained in the memory interface MI into address signals which are fed to the memory M and designated by A2 in the figure and which have to be used to actuate the memory M so that it outputs the data word containing the requested useful data. If the data processing device DV already outputs the address signals A2, the addressing logic can be dispensed with.

In response to the reception of the address signals A2, the memory M outputs the data word stored at this address, to be more precise both the useful data contained in it and the signature data contained in it. The data which is output from the memory M is referred to in the figure by the reference DS.

The data DS which is output from the memory M is fed to the memory interface MI, to be more precise a read logic contained in the memory interface MI. This read logic extracts, from the data word which is output from the memory M, the useful data which is referred to below as D1 and the signature data which is referred to below as S1.

The read logic feeds the useful data D1 to the data processing device DV and preferably in addition also to the signature generating device SGEN, and feeds the signature data S1 to the signature comparing device V.

Furthermore, data which is designated by D2 is fed to the signal generating device SGEN from the data generating device DGEN. The signature generating device SGEN generates, from the useful data D1 and/or the data D2, signature data S2 which is such
that the signature data S2 which is generated by the checking device CHK corresponds to the signature data S1 which is fed to the checking device CHK, if the data D1 which is output from the memory M can be released for use by the data processing device DV, and
that the signature data S2 which is generated by the checking device CHK does not correspond to the signature data S1 which is fed to the checking device CHK if the data D1 which is output from the memory M cannot be released for use by the data processing device DV.

Moreover, it is the case that both the signature data S2 which is generated by the checking device CHK and the signature data S1 which is fed to the checking device CHK contains information which represents specific properties of the data on which the generation of the signature data is based, and that the information which is contained in signature data S2 which is generated by the checking device CHK, and the information which is contained in the signature data S1 which is fed to the checking device CHK, represents the same properties. Furthermore, the information which is contained in signature data S2 which is generated by the checking device CHK, and the information which is contained in the signature data S1 which is fed to the checking device CHK, is coded in the same way.

The signature data S2 which is generated by the signal generating device SGEN is fed to the signal comparing device V which compares this signature data S2 to the signature data S1 and determines, as a function of the comparison result, whether the useful data can be released for use by the data processing device DV.

As has already been indicated at the beginning, the checking device CHK can check for the presence of various conditions.

One of the possible uses of the checking device CHK here is for the checking device to check whether the useful data D1 is free of errors, and whether the useful data has actually been read from the address from which it was supposed to have been read.

The fact that the useful data has actually been read from the address from which it was supposed to have been read cannot be taken for granted. Possible causes for why this may not be the case are,
that the data processing device DV outputs the incorrect address A1,
that the address A1 is not transmitted correctly to the addressing logic of the memory interface MI,
that the addressing logic of the memory interface MI converts the address A1 into an incorrect address A2,
that the address A2 is not transmitted correctly to the memory M, and/or
that the memory M outputs a data word which is stored at a different address than the address A2 which is fed to it.

If the checking device CHK is used to check whether the useful data D1 is free of errors and whether the useful data has been read from the address from which it was supposed to have been read,
the signature data which is stored together with the useful data in the data word containing the latter contains both information about the useful data and about the address at which the data word containing the useful data is stored in the memory M,
the data generating device DGEN outputs data D2 which represents the address from which the data processing device DV has to read data out of the memory M, and
the signature data S2 which is generated by the signal generating device SGEN is formed taking into account the data D1 and D2.

The fact that the data generating device DGEN outputs data D2 which represents the address from which the data processing device DV has to read data out of the memory M, can be implemented, for example, by virtue of the fact that the data generating device DGEN contains an address generating device which operates, and is actuated, like the address generating device of the data processing device DV.

In this case, it is possible to detect, from the result of the comparison which is carried out by the signature comparing device V, whether the useful data D1 is free of errors and whether the useful data has been read from the address from which it was supposed to have been read.

If it is detected, when the comparison is carried out by the signature comparing device V, that the compared signature data S1 and S2 is identical, it is possible to assume that the useful data D1 is free of errors, and that the useful data has actually been read from the address from which it was supposed to have been read. In this case, there is no reason for the useful data not to be used by the data processing device DV.

On the other hand, i.e. if the comparison carried out by the signature comparing device V reveals that the compared signature data S1 and S2 is not the same, it is necessary to assume that the useful data D1 is not free of errors and/or that the useful data has not been read from the address from which it was intended to be read. In this case, the data which is output from the memory M is not released for use by the data processing device DV.

By suitably generating the signature data it is possible to detect whether the useful data or the addressing is incorrect and, if the useful data is incorrect, to correct the useful data and to pass on the corrected useful data to the data processing device DV and to release it for use by the data processing device. This is possible, for example, if the information relating to the useful data within the signature data is formed by an ECC (error correction code). In this case, an error which is contained in the useful data could be corrected using the signature data S1.

It proves advantageous if a SECDED (single error correction, double error detection) code is used as the ECC. SECDED codes in fact generally have the property that they are only 2ⁿ-1 bits long and, since data words usually comprising 2ⁿ bits are used in the data processing, the word length which is available for the SECDED is consequently not fully utilized. If the bits which are not utilized by the SECDED code are used for the information relating to the address within the signature data, the checking as to whether the useful data has actually been read from the address from which it was supposed to have been read can be carried out with a minimum additional outlay. Of course, the number of bits which is available for the information relating to the address can be selected to be of any desired magnitude; there is therefore not necessarily a restriction here to the bits of a data word which are not used by the ECC.

If, as a result of the comparison of the signature data S1 and S2 which is carried out by the signature comparing device V, it is determined that the useful data which is read out of the memory M cannot be released for use by the data processing device DV, and it is also impossible to correct the detected error, the checking device CHK ensures that the data processing device DV does not receive or use the useful data which is output from the memory. This can be carried out, for example, by the useful data which is output from the memory S not being passed onto the data processing device DV, or by the checking device CHK generating an interrupt request which prevents the useful data which is output from the memory S from being processed by the data processing device DV.

During the possible use of the checking device CHK as described above, the checking device checks whether the useful data D1 is free of errors and whether the useful data has actually been read from the address from which it was supposed to have been read.

It would of course also be possible for the signature data S1 and S2 to contain only the information relating to the useful data, that is to say, for example, only an ECC. In this case, the signature comparing device V could “only” determine whether the useful data was free of errors. Likewise it would also be possible for the signature data S1 and S2 to contain only the memory address of the information relating to useful data. In this case, the signature comparing device could “only” determine whether there were errors in the memory addressing process.

With another possible use of the checking device CHK, the checking device can check whether the useful data which is output from the memory M can at all be read from the memory by the data processing device DV.

In this case,
the signature data S1 which is stored together with the useful data D1 in the data word containing this useful data contains the signature of an access control code,
the data generating device DGEN outputs data D2 which represents an access control code, and
the signature data S2 which is generated by the signature generating device SGEN is formed taking into account the data D2.

The access control code whose signature is contained in the signature data S1 represents conditions under which the useful data D1 to which the signature data is assigned can be accessed, or cannot be accessed.

This access control code can, for example, contain data about the phases in which the assigned useful data D1 can be accessed, or cannot be accessed. In this case, the data D2 which is output by the data generating device DGEN represents data about the current phase. In this way, it is possible for the signature data S1 to predefine, for example, that the useful data to which the signature data S1 is assigned can be read out from the memory M only during the initiation of the arrangement or of the system containing it, or only during the execution of a specific task, or only in a specific operating mode of the arrangement or of the system containing it, and passed onto the data processing device DV.

The access control code whose signature is contained in the signature data S1 can also contain information about the microcontroller components which can access, or cannot access, the useful data to which the signature data S1 is assigned. In this case, the data D2 which is output by the data generating device DGEN contains information about the device which is currently accessing the memory M. In this way, by means of the signature data S1 it is possible to predefine, for example, that the useful data to which the signature data S1 is assigned can be read out only by specific microcontroller components, or can be passed on only to specific microcontroller components.

The access control code whose signature is contained in the signature data S1 can, however, also be a code word of the user of the arrangement. In this case, the data D2 which is output by the data generating device DGEN represents a code word which is fed to the arrangement by the user of the arrangement. In this way, it is possible to predefine, by means of the signature data S1, for example, that useful data to which the signature data S1 is assigned can be read out of the memory M, or passed onto the data processing device DV, only if this has been approved by an authorized person by the inputting of a code word into the arrangement.

If the signature data S1 and S2 contains the signatures of access control codes, it is possible to detect, from the result of the comparison which is carried out by the signature comparing device V, whether or not the reading out of the useful data D1 assigned to the signature data S1 is admissible.

If the comparison which is carried out by the signature comparing device V reveals that the compared signature data S1 and S2 is identical, it is possible to assume that the reading out of the useful data D1 is admissible. In this case, there is no reason for the useful data not to be used by the data processing device DV.

Otherwise, i.e. if the comparison which is carried out by the signature comparing device V reveals that the compared signature data S1 and S2 is not identical, it must be assumed that the reading out of the useful data D1 from the memory M is not admissible. In this case, the useful data D1 which is output from the memory M is not released for use by the data processing device DV. In this case, the checking device CHK ensures that the data processing device DV does not contain or use the useful data which is output from the memory. This can be carried out, for example, by the useful data which is output from the memory S not being passed on to the data processing device DV, or by the checking device CHK generating an interrupt request which prevents the useful data which is output from the memory S from being processed by the data processing device DV.

With the possible use of the checking device CHK which has just been described, the signature data S1 and S2 contains the signature of an access control code. It is apparent, and does not require anymore detailed explanation, that the signature data S1 and S2 can also contain additional information, for example the information described above, which can be used to detect errors contained in the useful data and/or correct them, and/or which can be used to detect whether the useful data has actually been read from the address from which it was supposed to have been read.

The content of the signature data S1 and S2 is not restricted to the contents mentioned above but rather can also include any desired other information or combinations of information.

1. An arrangement comprising a data processing device and a memory for storing data which is required by the data processing device, wherein the arrangement comprises a checking device operable to
generate signature data when data is read out of the memory,
compare the generated signature data with signature data which is fed to the checking device and is assigned to the data which is output from the memory, and operable to
determine, as a function of the result of this comparison, whether the data which is output from the memory can be released for use by the data processing device.

2. The arrangement as claimed in claim 1, wherein the signature data which is fed to the checking device is stored in the arrangement.

3. The arrangement as claimed in claim 2, wherein the signature data which is fed to the checking device is stored in the memory.

4. The arrangement as claimed in claim 3, wherein the signature data which is fed to the checking device is stored at the same address as the data to which said signature data is assigned, with the result that, when data is read out of the memory, both the data which is to be read out and the signature data which is assigned thereto is output from the memory.

5. The arrangement as claimed in claim 1, wherein the checking device generates the signature data to be generated by it, in such a way
that the signature data which is generated by the checking device corresponds to the signature data which is fed to the checking device if the data which is output from the memory can be released for use by the data processing device, and
that the signature data which is generated by the checking device does not correspond to the signature data which is fed to the checking device if the data which is output from the memory cannot be released for use by the data processing device.

6. The arrangement as claimed in claim 1, wherein both the signature data which is generated by the checking device and the signature data which is fed to the checking device contains information which represents specific properties of the data on which the generation of the signature data is based, and wherein the information which is contained in signature data which is generated by the checking device, and the information which is contained in the signature data which is fed to the checking device, represents the same properties.

7. The arrangement as claimed in claim 1, wherein the information which is contained in signature data which is generated by the checking device, and the information which is contained in the signature data which is fed to the checking device, is coded in the same way.

8. The arrangement as claimed in claim 1, wherein the signature data which is fed to the checking device contains information about the data to which it is assigned.

9. The arrangement as claimed in claim 8, wherein the signature data which is fed to the checking device contains an error correction code, which is used to detect errors which are present in the data which is assigned to the signature data.

10. The arrangement as claimed in claim 9, wherein the signature data which is fed to the checking device contains a single error correction double error detection code.

11. The arrangement as claimed in claim 8, wherein the data which is output from the memory is fed to the checking device, and wherein the data which is output from the memory is used as the basis for the generation of signature data which is performed by the checking device.

12. The arrangement as claimed in claim 1, wherein the signature data which is fed to the checking device contains information about the address at which the data to which the signature data is assigned is stored in the memory.

13. The arrangement as claimed in claim 12, wherein the checking device contains a data generating device which outputs the address from which the data processing device would have to read data out of the memory, and wherein the address which is output by the data generating device is used as the basis for the generation of signature data which is to be performed by the checking device.

14. The arrangement as claimed in claim 1, wherein the signature data which is fed to the checking device contains the signature of an access control code, the access control code representing conditions under which the data to which the signature data is assigned can be accessed or cannot be accessed.

15. The arrangement as claimed in claim 14, wherein the checking device comprises a data generating device which outputs data which represents the instantaneous status of the arrangement, or the instantaneous status of the system containing the arrangement, or the instantaneous status of a specific component of the system containing the arrangement, and wherein the data which is output from the data generating device is used as the basis for the generation of signature data which is to be performed by the checking device.

16. The arrangement as claimed in claim 14, wherein the checking device comprises a data generating device which outputs data which contains information about the device which accesses the memory at a particular time, and wherein the data which is output from the data generating device is used as the basis for the generation of signature data which is to performed by the checking device.

17. The arrangement as claimed in claim 14, wherein the checking device comprises a data generating device which outputs a code word which is fed to the arrangement by the user of the arrangement, and wherein the code word which is output from the data generating device is used as the basis for the generation of signature data which is to be performed by the checking device.

18. The arrangement as claimed in claim 1, wherein the checking device and the remaining components of the arrangement are components of various local domains of the circuit forming the arrangement.

19. The arrangement as claimed in claim 1, wherein the checking device comprises a data generating device, a signature generating device and a signature comparing device.

20. The arrangement as claimed in claim 19, wherein the signature generating device which generates the signature data which is to be generated by the checking device, data which is fed to the signature generating device by the data generating device and/or by a component of the arrangement which is not associated with the checking device being used as the basis for the generation of signature data.

21. The arrangement as claimed in claim 19, wherein the signature comparing device carries out the comparison which is to be carried out by the checking device, the signature data which is generated by the signature generating device and the signature data which is fed to the signature comparing device from outside the checking device being compared by the comparison.

22. The arrangement as claimed in claim 19, wherein the data generating device and the signature generating device on the one hand, and the signature comparing device on the other, are components of different local domains of the circuit forming the arrangement.
